(19) United States
(12) Patent Application Publication
(10) Pub. No.: US 2016/0295350 A1
(43) Pub. Date: Oct. 6, 2016

(54) METHOD, APPARATUS, AND COMPUTER PROGRAM PRODUCT FOR CHANNEL USAGE INFORMATION DELIVERY WITHIN A PEER-TO-PEER GROUP

(71) Applicant: Nokia Technologies Oy, Espoo (FI)

(72) Inventors: Olli ALANEN, Vantaa (FI); Mika KASSLIN, Espoo (FI); Jarkko KNECKT, Espoo (FI); Janne MARIN, Espoo (FI)

(21) Appl. No.: 14/678,382

(22) Filed: Apr. 3, 2015

(51) Int. Cl. H04W 4/00; H04W 72/12

(52) U.S. Cl. CPC H04W 4/008; H04W 72/1257

(57) ABSTRACT

A method to manage of coexistence between infrastructure networks and peer-to-peer groups, including receiving, by a peer-to-peer wireless client device associated with a peer-to-peer wireless group owner device in a peer-to-peer wireless network, channel usage information of a wireless infrastructure network, from a wireless access point device managing the wireless infrastructure network; and transmitting, by the peer-to-peer wireless client device, the received channel usage information of the wireless infrastructure network, to the peer-to-peer wireless group owner device, as coexistence information.

### FIELD

The field of the invention relates to wireless short-range communication and more particularly to management of coexistence between infrastructure networks and peer-to-peer groups.

### BACKGROUND

Modern society has adopted, and is becoming reliant upon, wireless communication devices for various purposes, such as, connecting users of the wireless communication devices with other users. Wireless communication devices can vary from battery powered handheld devices to household and/or commercial devices utilizing electrical network as a power source. Due to rapid development of the wireless communication devices a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, such as GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra-high frequency radio frequency identification (UHF RFID) technologies. All of these wireless communication technologies have features that make them appropriate for various applications.

### SUMMARY

Method, apparatus, and computer program product example embodiments enable management of coexistence between infrastructure networks and peer-to-peer groups.

According to an example embodiment of the invention, a method comprises:

receiving, by a peer-to-peer wireless client device associated with a peer-to-peer wireless group owner device in a peer-to-peer wireless network, channel usage information of a wireless infrastructure network, from a wireless access point device managing the wireless infrastructure network; and

transmitting, by the peer-to-peer wireless client device, the received channel usage information of the wireless infrastructure network, to the peer-to-peer wireless group owner device, as coexistence information.

According to an example embodiment of the invention, a method comprises:

transmitting, by the peer-to-peer wireless client device, to the wireless access point device, a probe request frame that includes a channel usage element; and

receiving, by the peer-to-peer wireless client device, from the wireless access point device, a probe response frame that includes the channel usage information;

wherein the peer-to-peer wireless client device is not associated with the wireless access point device.

According to an example embodiment of the invention, a method comprises:

transmitting, by the peer-to-peer wireless client device, to the wireless access point device, a channel usage request frame; and

receiving, by the peer-to-peer wireless client device, from the wireless access point device, a channel usage response frame that includes the channel usage information, the channel usage response frame optionally also comprising one or more of power constraint information, Enhanced Distributed Channel Access parameter set information, and transmit power envelope information;

wherein the peer-to-peer wireless client device is associated with the wireless access point device.

According to an example embodiment of the invention, a method comprises:

embedding, by the peer-to-peer wireless client device, the coexistence information in an association request frame; and

transmitting, by the peer-to-peer wireless client device, the association request frame to the peer-to-peer wireless group owner device.

According to an example embodiment of the invention, a method comprises:

transmitting, by the peer-to-peer wireless client device, the coexistence information in a channel usage response frame to the peer-to-peer wireless group owner device.

According to an example embodiment of the invention, a method comprises:

receiving, by the peer-to-peer wireless client device, updated channel usage information of the wireless infrastructure network, from the wireless access point device; and

transmitting, by the peer-to-peer wireless client device, the received updated channel usage information, to the peer-to-peer wireless group owner device, as updated coexistence information, when the updated information is received.

According to an example embodiment of the invention, a method comprises:

receiving, by the peer-to-peer wireless client device, a channel switch announcement message from the peer-to-peer wireless group owner device, including channel switch selection information of the peer-to-peer wireless network, in response to the coexistence information transmitted to the peer-to-peer wireless group owner device; and

transmitting, by the peer-to-peer wireless client device, the received channel switch selection information to the wireless access point device.

According to an example embodiment of the invention, a method comprises:

storing, by the peer-to-peer wireless client device, the coexistence information;

associating, by the peer-to-peer wireless client device, with a second peer-to-peer wireless group owner device in a second peer-to-peer wireless network; and

transmitting, by the peer-to-peer wireless client device, the stored coexistence information, to the second peer-to-peer wireless group owner device.

According to an example embodiment of the invention, an apparatus comprises:

at least one processor;

at least one memory including computer program code;

the at least one memory and the computer program code configured to, with the at least one processor, cause the apparatus at least to:

receive by the apparatus associated with a peer-to-peer wireless group owner device in a peer-to-peer wireless network, channel usage information of a wireless infrastructure network, from a wireless access point device managing the wireless infrastructure network; and

transmit the received channel usage information of the wireless infrastructure network, to the peer-to-peer wireless group owner device, as coexistence information.

According to an example embodiment of the invention, an apparatus comprises:

the at least one memory and the computer program code configured to, with the at least one processor, cause the apparatus at least to:

transmit to the wireless access point device, a probe request frame that includes a channel usage element; and

receive from the wireless access point device, a probe response frame that includes the channel usage information;

wherein the apparatus is not associated with the wireless access point device.

According to an example embodiment of the invention, an apparatus comprises:

the at least one memory and the computer program code configured to, with the at least one processor, cause the apparatus at least to:

transmit to the wireless access point device, a channel usage request frame; and

receive from the wireless access point device, a channel usage response frame that includes the channel usage information, the channel usage response frame optionally also comprising one or more of power constraint information, Enhanced Distributed Channel Access parameter set information, and transmit power envelope information;

wherein the apparatus is associated with the wireless access point device.

According to an example embodiment of the invention, an apparatus comprises:

the at least one memory and the computer program code configured to, with the at least one processor, cause the apparatus at least to:

embed the coexistence information in an association request frame; and

transmit the association request frame to the peer-to-peer wireless group owner device.

According to an example embodiment of the invention, an apparatus comprises:

the at least one memory and the computer program code configured to, with the at least one processor, cause the apparatus at least to:

transmit the coexistence information in a channel usage response frame to the peer-to-peer wireless group owner device.

According to an example embodiment of the invention, an apparatus comprises:

the at least one memory and the computer program code configured to, with the at least one processor, cause the apparatus at least to:

receive updated channel usage information of the wireless infrastructure network, from the wireless access point device; and

transmit the received updated channel usage information, to the peer-to-peer wireless group owner device, as updated coexistence information, when the updated information is received.

According to an example embodiment of the invention, an apparatus comprises:

the at least one memory and the computer program code configured to, with the at least one processor, cause the apparatus at least to:

receive a channel switch announcement message from the peer-to-peer wireless group owner device, including channel switch selection information of the peer-to-peer wireless network, in response to the coexistence information transmitted to the peer-to-peer wireless group owner device; and

transmit the received channel switch selection information to the wireless access point device.

According to an example embodiment of the invention, an apparatus comprises:

the at least one memory and the computer program code configured to, with the at least one processor, cause the apparatus at least to:

store the coexistence information;

associate with a second peer-to-peer wireless group owner device in a second peer-to-peer wireless network; and

transmit the stored coexistence information, to the second peer-to-peer wireless group owner device.

According to an example embodiment of the invention, a computer program product comprises computer executable program code recorded on a computer readable non-transitory storage medium, the computer executable program code comprising:

code for receiving, by a peer-to-peer wireless client device associated with a peer-to-peer wireless group owner device in a peer-to-peer wireless network, channel usage information of a wireless infrastructure network, from a wireless access point device managing the wireless infrastructure network; and

code for transmitting, by the peer-to-peer wireless client device, the received channel usage information of the wireless infrastructure network, to the peer-to-peer wireless group owner device, as coexistence information.

According to an example embodiment of the invention, a computer program product comprises:

code for transmitting, by the peer-to-peer wireless client device, to the wireless access point device, a probe request frame that includes a channel usage element; and

code for receiving, by the peer-to-peer wireless client device, from the wireless access point device, a probe response frame that includes the channel usage information;

wherein the peer-to-peer wireless client device is not associated with the wireless access point device.

According to an example embodiment of the invention, a computer program product comprises:

code for transmitting, by the peer-to-peer wireless client device, to the wireless access point device, a channel usage request frame; and

code for receiving, by the peer-to-peer wireless client device, from the wireless access point device, a channel usage response frame that includes the channel usage information, the channel usage response frame optionally also comprising one or more of power constraint information, Enhanced Distributed Channel Access parameter set information, and transmit power envelope information;

wherein the peer-to-peer wireless client device is associated with the wireless access point device.

According to an example embodiment of the invention, a computer program product comprises:

code for embedding, by the peer-to-peer wireless client device, the coexistence information in an association request frame; and

code for transmitting, by the peer-to-peer wireless client device, the association request frame to the peer-to-peer wireless group owner device.

According to an example embodiment of the invention, a computer program product comprises:

code for transmitting, by the peer-to-peer wireless client device, the coexistence information in a channel usage response frame to the peer-to-peer wireless group owner device.

According to an example embodiment of the invention, a computer program product comprises:

code for receiving, by the peer-to-peer wireless client device, updated channel usage information of the wireless infrastructure network, from the wireless access point device; and

code for transmitting, by the peer-to-peer wireless client device, the received updated channel usage information, to the peer-to-peer wireless group owner device, as updated coexistence information, when the updated information is received.

According to an example embodiment of the invention, a computer program product comprises:

code for receiving, by the peer-to-peer wireless client device, a channel switch announcement message from the peer-to-peer wireless group owner device, including channel switch selection information of the peer-to-peer wireless network, in response to the coexistence information transmitted to the peer-to-peer wireless group owner device; and

code for transmitting, by the peer-to-peer wireless client device, the received channel switch selection information to the wireless access point device.

According to an example embodiment of the invention, a method comprises:

receiving, by a peer-to-peer wireless group owner device in a peer-to-peer wireless network, an association request frame or a channel usage response frame from a peer-to-peer wireless client device, including coexistence information of a wireless infrastructure network, the peer-to-peer wireless client device concurrently operating with a wireless access point device managing the wireless infrastructure network; and

determining, by the peer-to-peer wireless group owner device, to switch the peer-to-peer wireless network to another channel in response to the received coexistence information of the wireless infrastructure network.

According to an example embodiment of the invention, an apparatus comprises:

at least one processor;

at least one memory including computer program code;

the at least one memory and the computer program code configured to, with the at least one processor, cause the apparatus at least to:

receive in a peer-to-peer wireless network, an association request frame or a channel usage response frame from a peer-to-peer wireless client device, including coexistence information of a wireless infrastructure network, the peer-to-peer wireless client device concurrently operating with a wireless access point device managing the wireless infrastructure network; and

determine to switch the peer-to-peer wireless network to another channel in response to the received coexistence information of the wireless infrastructure network.

### DESCRIPTION OF THE FIGURES

FIG. 1 illustrates an example network diagram of a peer-to-peer wireless client device, which is a Managed P2P Client Device, associated with a peer-to-peer wireless group owner device in a peer-to-peer wireless network, transmitting a channel usage request message to a wireless access point device managing a wireless infrastructure network. The peer-to-peer wireless client device is concurrently operating with the wireless access point device. The further figure shows the peer-to-peer wireless client device receiving a channel usage response message from the wireless access point device, including coexistence information of the wireless infrastructure network. The further figure shows the peer-to-peer wireless client device transmitting the received coexistence information to the peer-to-peer wireless group owner device, in accordance with at least one embodiment of the present invention.

FIG. 2 illustrates a signal sequence diagram of the network shown in FIG. 1, wherein the peer-to-peer wireless client device is not presently associated with the peer-to-peer wireless group owner device. The figure shows the peer-to-peer wireless client device embedding the received coexistence information in an association request frame and transmitting the association request frame to the peer-to-peer wireless group owner device, in accordance with at least one embodiment of the present invention.

FIG. 3 illustrates a signal sequence diagram of the network shown in FIG. 1, wherein the peer-to-peer wireless client device is not presently associated with the peer-to-peer wireless group owner device. The figure shows the peer-to-peer wireless client device transmitting an association request frame to the peer-to-peer wireless group owner device, receiving an association response frame and becoming associated with the peer-to-peer wireless group owner device. The figure then shows the peer-to-peer wireless client device transmitting the received coexistence information as a channel usage response frame to the peer-to-peer wireless group owner device, in accordance with at least one embodiment of the present invention.

FIG. 4 illustrates a signal sequence diagram of the network shown in FIG. 1, wherein the peer-to-peer wireless client device is shown receiving an updated channel usage response message from the wireless access point device, including updated coexistence information of the wireless infrastructure network. The figure further shows the peer-to-peer wireless client device transmitting the received updated coexistence information to the peer-to-peer wireless group owner device, in accordance with at least one embodiment of the present invention.

FIG. 5A illustrates a management frame format containing a channel usage response action field, in accordance with at least one embodiment of the present invention.

FIG. 5B illustrates an action frame body frame format containing the channel usage response action field, in accordance with at least one embodiment of the present invention.

FIG. 5C illustrates an action field general format, in accordance with at least one embodiment of the present invention.

FIG. 5D illustrates the channel usage response action field, in accordance with at least one embodiment of the present invention.

FIG. 5E illustrates the channel usage element format in the channel usage response action field, in accordance with at least one embodiment of the present invention.

FIG. 5F illustrates the optional power constraint element format in the channel usage response action field, in accordance with at least one embodiment of the present invention.

FIG. 5G illustrates the optional Enhanced Distributed Channel Access (EDCA) parameter set element format in the channel usage response action field, in accordance with at least one embodiment of the present invention.

FIG. 5H illustrates the optional transmit power envelope element format in the channel usage response action field, in accordance with at least one embodiment of the present invention.

FIG. 6 illustrates the association request frame body format with coexistence information, transmitted in the association request, in accordance with at least one embodiment of the present invention.

FIG. 7A illustrates an example flow diagram of operational steps in the peer-to-peer wireless client device, in accordance with at least one embodiment of the present invention.

FIG. 7B illustrates an example flow diagram of operational steps in the peer-to-peer wireless group owner device, in accordance with at least one embodiment of the present invention.

FIG. 8A is an illustrates an example network diagram and functional block diagram of the access point device and the peer-to-peer wireless client device, in accordance with at least one embodiment of the present invention.

FIG. 8B is an illustrates an example network diagram and functional block diagram of the peer-to-peer wireless client device and the peer-to-peer wireless group owner device, in accordance with at least one embodiment of the present invention.

FIG. 9 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with an example embodiment of the invention.

### DISCUSSION OF EXAMPLE EMBODIMENTS OF THE INVENTION

This section is organized into the following topics:

A. WLAN Communication Technology

B. Wi-Fi Peer-to-Peer Technology

C. Channel Usage Information Delivery Within A Peer-To-Peer Group

A. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j, k, n, r, s, u, v, and z protocols, into the base standard IEEE 802.11-2012, Wireless Medium Access Control (MAC) and Physical Layer (PHY) Specifications, February 2012. Since then, emerging broadband applications have stimulated interest in developing very high-speed wireless networks for short range communication, for example, the planned IEEE 802.11 ac, and the planned IEEE 802.11 ad WLAN specifications that are to provide a very high throughput in various frequency bands. Applications of these IEEE 802.11 standards include products such as consumer electronics, telephones, personal computers, and access points for both for home and office.

1. IEEE 802.11 MAC Frames and Information Elements

There are three major types of medium access control (MAC) frames in the IEEE 802.11 protocol: the management frame, the control frame, and the data frame. Management frames provide management services. Data frames carry payload data. Control frames assist in the delivery of data frames. Each of these types of MAC frame consists of a MAC header, a frame body, and a frame check sequence (FCS). The header contains control information used for defining the type of 802.11 MAC frame and providing information necessary to process the MAC frame. The frame body contains the data or information included in either management type or data type frames. The frame check sequence is a value representing a cyclic redundancy check (CRC) over all the fields of the MAC header and the frame body field.

Management frames are used to provide management services that may be specified by variable-length fields called information elements included in the MAC frame body. An information element includes three fields: its function is identified by an element ID field, its size is provided by a length field, and the information to deliver to the recipient is provided in a variable-length information field.

2. IEEE 802.11 Beacon, Probe Request and Response

a. Beacon

The beacon frame is a management frame that is transmitted periodically to allow wireless devices to locate and identify a network. The beacon frame includes the fields: timestamp, beacon interval, and capability information. The timestamp contains the value of the device's synchronization timer at the time that the frame was transmitted. The capability information field is a 16-bit field that identifies the capabilities of the device. The information elements in a beacon frame are the service set identifier (SSID), the supported rates, one or more physical parameter sets, an optional contention-free parameter set, and an optional traffic indication map.

i. Infrastructure BSS Networks with an Access Point

In an Infrastructure BSS Networks with an Access Point, beacon frames are used for enabling wireless devices to establish and maintain orderly communications. The beacon frames are transmitted by the Access Points at regular intervals and include a frame header and a body with various information, including a Service Set Identifier (SSID) identifying the name of a specific WLAN and a beacon interval specifying the intended time interval between two beacon transmissions. One important purpose of the beacon frames is to inform the wireless devices about the presence of an Access Point in the area. The access point in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point in an Infrastructure BSS may bridge traffic out of the BSS onto a distribution network. STAs that are members of the BSS may exchange packets with the AP.

ii. Ad Hoc IBSS Networks

The first ad hoc wireless device to become active establishes an IBSS and starts sending beacons to inform the other wireless devices about the presence of an ad hoc network in the area. Other ad hoc wireless devices may join the network after receiving a beacon and accepting the IBSS parameters, such as the beacon interval, found in the beacon frame.

Each wireless device that joins the ad hoc network may send a beacon periodically if it doesn't hear a beacon from another device within a short random delay period after the beacon is supposed to be sent. If a wireless device doesn't hear a beacon within the random delay period, then the wireless device assumes that no other wireless devices are active in the ad hoc network and a beacon needs to be sent.

A beacon signal is periodically transmitted from the ad hoc network. The beacon frame is transmitted periodically and includes the address of the sending device.

b. Probe Request

The probe request frame is a management frame that is transmitted by a wireless device attempting to quickly locate a wireless LAN. It may be used to locate independent basic service sets (IBSSs), infrastructure basic service sets (BSSs) or mesh basic service sets (MBSSs) only or any of them. It may be used to locate a wireless LAN with a particular SSID or to locate any wireless LAN. The probe request frame may contain a service attribute request.

For active scans, the wireless device either broadcasts or unicasts a probe request on the channel it is scanning. It may set the SSID in the probe request to a wildcard SSID or to a specific SSID value. It may set the BSSID in the probe request a wildcard BSSID or to a specific BSSID value. With these options the wireless device can look for any SSID or BSSID, any representative of a specific SSID or a specific BSSID. The wireless device will add any received beacons or probe responses to a cached basic service set identifier (BSSID) scan list. For passive scans, the wireless device does not send a probe request, but instead, listens on a channel for a period of time and adds any received beacons or probe responses to its cached BSSID scan list. The wireless device may scan both infrastructure and ad hoc networks, regardless of the current setting of its network mode. The wireless device may use either the active or passive scanning methods, or a combination of both scanning methods. The wireless device performs the scan across all the frequency channels and bands that it supports.

i. Infrastructure BSS Networks with an Access Point

The wireless device may transmit a probe request and receive a probe response from the access point AP in the BSS. The probe request is transmitted by a wireless device to obtain information from another station or access point. For example, a wireless device may transmit a probe request to determine whether a certain access point is available. In the infrastructure BSS, only the AP responds to probe requests. The probe response sent back by the AP contains a timestamp, beacon interval, and capability information. It also includes the Service Set Identity (SSID) of the BSS, supported rates, and PHY parameters. The wireless device STA may learn that the access point AP will accept the STA's credentials.

The rules applied by the scanning wireless device (i.e. scanner) and the APs with active scanning are as follows:

1) Scanner (for each channel to be scanned):
a. Transmit a probe request frame (or multiple of thereof) with the SSID and the BSSID fields set as per the scan command;
b. Reset ProbeTimer to zero and start it upon the probe request transmission;
c. If nothing is detected (any signal with high enough energy) on the channel before the ProbeTimer reaches MinChannelTime (a.k.a Min_Probe_Response_Time), then go to scan the next channel (if any), else when the ProbeTimer reaches MaxChannelTime (i.e., Max_Probe_Response_Time), process all received probe responses and go to scan the next channel (if any).

2) APs:
a. An AP shall respond with a probe response only if:
   i. The Address 1 field in the probe request frame is the broadcast address or the specific MAC address of the AP; and
   ii. The SSID in the probe request is the wildcard SSID, the SSID in the probe request is the specific SSID of the AP, or the specific SSID of the AP is included in the SSID list element of the probe request, or the Address 3 field in the probe request is the wildcard BSSID or the BSSID of the AP.
b. Some further conditions may be set as well for the generation of a probe response.

In general, the probe request transmitter specifies the conditions that wireless devices need to meet in order to respond to with a probe response. All wireless devices that fulfill the condition try to send a probe response frame. The active scanning mechanism defines the signaling.

ii. Ad Hoc IBSS Networks

The effect of receiving a probe request is to cause the wireless device to respond with a probe response if the conditions indicated in the probe request are met. When a wireless device arrives within the communication range of any member of an ad hoc network, its probe request frame inquiry signals are answered by a member of the ad hoc network detecting the inquiry. A device in an ad hoc network that broadcasted the latest beacon in the network responds to the probe request frame inquiry signals with a probe response containing the address of the responding device. The probe response frame also includes the timestamp, beacon interval, capability information, information elements of the SSID, supported rates, one or more physical parameter sets, the optional contention-free parameter set, and the optional ad hoc network parameter set.

Once a device has performed an inquiry that results in one or more ad hoc network descriptions, the device may choose to join one of the ad hoc networks. The joining process may be a purely local process that occurs entirely internal to the wireless device. There may be no indication to the outside world that a device has joined a particular ad hoc network. Joining an ad hoc network may require that all of the wireless device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the wireless device has joined the ad hoc network and is ready to begin communicating with the devices in the ad hoc network.

c. Probe Response

The probe response sent back by a wireless device that met the conditions set by the received probe request contains a timestamp, beacon interval, and capability information. It also includes the Service Set Identity (SSID) of the BSS, supported rates, and PHY parameters.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear to send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 and before a probe response is transmitted, wireless devices normally employ a spectrum sensing capability during the SIFS interval or DIFS interval, to detect whether the channel is busy. A carrier sensing scheme may be used wherein a node wishing to transmit a probe response has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission of a probe response for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle for a predetermined time interval. After every received frame one may however wait for a DIFS before sensing the channel status and resuming backoff counter update.

3. Channel Usage Procedures

Channel Usage information is a set of channels provided by an AP to non-AP STAs for operation of a noninfrastructure network or an off-channel Tunneled Direct Link Setup (TDLS) direct link. The Channel Usage information provided by the AP to the non-AP STA is to advise the STA on how to co-exist with the infrastructure network.

Implementation of Channel Usage is optional for a Wireless Network Management (WNM) STA. A STA that implements Channel

Usage has dot11MgmtOptionChannelUsageImplemented set to true. When dot11MgmtOptionChannelUsageImplemented is true, dot11WirelessManagementImplemented shall be true. A STA that has a value of true for dot11MgmtOptionChannelUsageActivated is defined as a STA that supports Channel Usage. A STA for which dot11MgmtOptionChannelUsageActivated is true shall set the Channel Usage field of the Extended Capabilities element to 1.

A non-AP STA that supports Channel Usage and is not associated to an AP prior to using a noninfrastructure network or an off channel TDLS direct link, may transmit a Probe Request frame including both Supported Operating Classes and Channel Usage elements. A non-AP STA supporting Channel Usage may send a Channel Usage Request frame at any time after association to the AP that supports the use of Channel Usage to request the Channel Usage information for supported operating classes.

Upon receipt of a Channel Usage element in the Probe Request frame, the AP supporting Channel Usage shall send a Probe Response frame including one or more Channel Usage elements. Upon receiving a Channel Usage Request frame, the AP supporting Channel Usage shall send a Channel Usage Response frame including one or more Channel Usage elements. Channel Usage elements shall only include channels that are valid for the regulatory domain in which the AP transmitting the element is operating and consistent with the Country element in the Beacon or Probe Response frame. When the Channel Usage element in a received Probe Request or Channel Usage Request frame includes one or more Operating Class/Channel Pair fields, the Operating Class/Channel Pair field(s) indicate(s) the requested non-AP STA operating class/channels for the usage mode indicated in the frame.

The AP may send an unsolicited group addressed or individually addressed Channel Usage Response frame to the STAs that have requested Channel Usage information, if the corresponding Channel Usage information needs to be updated. The Country element shall be included in the unsolicited and/or group addressed Channel Usage Response frame. The AP may include the Power Constraint information and Enhanced Distributed Channel Access (EDCA) Parameter in the Channel Usage Response frame. The values of the fields in the Power Constraint and EDCA Parameter Set elements included in the Channel Usage Response frame shall be the same values of the fields in the Power Constraint and EDCA Parameter Set elements that are transmitted by the AP.

Upon receipt of a Channel Usage element in the Probe Response or Channel Usage Response frame, the receiving STA may use the following:
The channel usage information as part of channel selection processing to start a noninfrastructure network or an off-channel TDLS direct link;
The Power Constraint element, if present, as part of determining its maximum transmit power for transmissions for the noninfrastructure network or an off-channel TDLS direct link;
The EDCA Parameter Set element, if present, as part of determining its EDCA parameters for transmissions for the noninfrastructure network or an off-channel TDLS direct link.

If either a recommended operating class, or a recommended channel, or both are not supported or understood by the recipient, or if the operating country of the sender is unknown, the recipient shall discard the corresponding channel usage recommendation. A STA that has not requested Channel Usage information shall discard an unsolicited group addressed Channel Usage Response frame.

Channel Usage Request Frame Format

The Channel Usage Request frame is sent by a non-AP STA to the AP to request the specified Channel Usage information. The format of the Channel Usage Request frame is defined as follows:

| | | | | | Supported |
|---|---|---|---|---|---|
| | | | | Channel | Operating |
| | | | Dialog | Usage | Classes |
| | Category | Action | Token | Elements | Element |
| Octets: | 1 | 1 | 1 | variable | variable |

The Category field is the value indicating the Wireless Network Management (WNM) category.

The Action field is the value indicating Channel Usage Request frame.

The Dialog Token field is a nonzero value chosen by the non-AP STA sending the Channel Usage Request frame to identify the request/response transaction.

The Channel Usage Element field includes one or more Channel Usage elements to identify the request Usage Mode.

The Supported Operating Classes Element field includes a Supported Operating Classes element to indicate the supported operating classes for the requested network type, consistent with the Country element advertised by the AP.

Channel Usage Response Frame Format

The Channel Usage Response frame is sent by an AP STA in response to a Channel Usage Request frame, or autonomously. The format of the Channel Usage Response frame is shown as follows:

| | | | | | | | EDCA |
|---|---|---|---|---|---|---|---|
| | | | | | | Power | Parameter |
| | | | | Channel | | Constraint | Set |
| | | | Dialog | Usage | Country | Element | Element |
| | Category | Action | Token | Elements | String | (optional) | (optional) |
| Octets: | 1 | 1 | 1 | variable | 3 | 0 or 3 | 0 or 20 |

The Category field is the value indicating the Wireless Network Management (WNM) category.

The Action field is the value indicating Channel Usage Response frame.

The Dialog Token field is the nonzero value received in the Channel Usage Request frame if the Channel Usage Response frame is being transmitted in response to a Channel Usage Request frame. The Dialog Token field is 0 if the Channel Usage Response frame is being transmitted other than in response to a Channel Usage Request frame.

The Channel Usage Element field includes zero or more Channel Usage elements. The Country String field is the value contained in the dot11CountryString attribute.

The Power Constraint Element field includes zero or one Power Constraint elements.

The EDCA Parameter Set Element field includes zero or one EDCA Parameter Set elements.

B. Wi-Fi Peer-to-Peer Technology

The Wi-Fi Alliance has developed a Wi-Fi Peer-to-Peer technology named Wi-Fi Direct™ that is specified in the Wi-Fi Alliance Peer-to-Peer Specification, October 2010 (incorporated herein by reference). Wi-Fi Direct, is also referred to herein as Peer-to-Peer or P2P. Wi-Fi Direct enables IEEE 802.11a, g, or n devices to connect to one another, peer-to-peer, without prior setup or the need for wireless access points. Wi-Fi Direct embeds a software access point into any device, which provides a version of Wi-Fi Protected Setup. When a device enters the range of a STA supporting Wi-Fi Direct (a Wi-Fi Direct device), it can connect to it and then gather setup information using a Wi-Fi Protected Setup transfer. Devices that support Wi-Fi Direct may discover one another and advertise available services. Wi-Fi Direct devices support typical Wi-Fi ranges and the same data rates as can be achieved with an 802.11a, g, or n infrastructure connection. When a device enters the range of the Wi-Fi Direct device, it may connect to it using the existing protocol, and then gather setup information using a Wi-Fi Protected Setup 2.0 transfer.

Wi-Fi Direct enables IEEE 802.11 devices that support Wi-Fi Direct, to connect to one another, point-to-point. The specification may be implemented in any Wi-Fi device. Devices that support the specification will be able to discover one another and advertise available services. Wi-Fi Direct devices will support typical Wi-Fi ranges and the same data rates as can be achieved with an infrastructure connection. Wi-Fi Direct provides point-to-point connections for networks by embedding a software access point into any device that wishes to support Wi-Fi Direct. The soft AP provides a version of Wi-Fi Protected Setup 2.0. When a device enters the range of the Wi-Fi Direct device, it may connect to it using the existing protocol, and then gather setup information using a Wi-Fi Protected Setup 2.0 transfer.

Wi-Fi Direct-certified devices may create direct connections between Wi-Fi client devices without requiring the presence of a traditional Wi-Fi infrastructure network of an access point or router. Wi-Fi Direct-certified devices support connection with existing legacy Wi-Fi devices using the IEEE 802.11 a/g/n protocols. Wi-Fi Direct Device Discovery and Service Discovery features allow users to identify available devices and services before establishing a connection, for example, discovering which Wi-Fi device is a printer.

A Wi-Fi Direct device may support an infrastructure network of an access point or router in addition to a peer-to-peer (P2P) connection. Wi-Fi Direct devices may join infrastructure networks as stations (STAs) and may support Wi-Fi Protected Setup enrollee functionality. Wi-Fi Direct devices may connect by forming Groups in a one-to-one or one-to-many topology. The Groups functions in a manner similar to an infrastructure basic service set (BSS). A single Wi-Fi Direct device will be the Group Owner (GO) that manages the Group, including controlling which devices are allowed to join and when the Group is started or terminated. The Group Owner (GO) will appear as an access point to legacy client's devices.

Wi-Fi Direct devices include a Wi-Fi Protected Setup Internal Registrar functionality and communication between Clients in the Group. Wi-Fi Direct devices may be a Group Owner (GO) of a Group and may be able to negotiate which device adopts this role when forming a Group with another Wi-Fi Direct device. A Group may include both Wi-Fi Direct devices and legacy devices (i.e., that are not compliant with the Wi-Fi Alliance Peer-to-Peer Specification). Legacy Devices can only function as Clients within a Group.

Wi-Fi Direct devices support Discovery mechanisms. Device Discovery is used to identify other Wi-Fi Direct devices and establish a connection by using a scan similar to that used to discover infrastructure access points. If the target is not already part of a Group, a new Group may be formed. If the target is already part of a Group, the searching Wi-Fi Direct device may attempt to join the existing Group. Wi-Fi Protected Setup may be used to obtain credentials from the Group Owner (GO) and authenticate the searching Wi-Fi Direct device. Wi-Fi Direct devices may include Service Discovery that enables the advertisement of services supported by higher layer applications to other Wi-Fi Direct devices. Service Discovery may be performed at any time (e.g. even before a connection is formed) with any other discovered Wi-Fi Direct device.

A Group may be created by a single Wi-Fi Direct device, such as when connecting a legacy device. When forming a connection between two Wi-Fi Direct devices, a Group may be formed automatically and the devices may negotiate to determine which device is the Group Owner. The Group Owner may decide if this is a temporary (single instance) or persistent (multiple, recurring use) Group. After a Group is formed, a Wi-Fi Direct device may invite another Wi-Fi Direct device to join the Group. The decision of whether or not to accept an invitation may be left to the invited Wi-Fi Direct device.

Wi-Fi Direct Devices may participate in multiple Groups. A Wi-Fi Direct Device that may be in a Group while maintaining a WLAN infrastructure connection at the same time is considered a Concurrent Device or a dual stack device. For example, a laptop connected directly to a printer while simultaneously using a WLAN connection is operating as a Concurrent Device. Concurrent connections may be supported by a single radio and may support connections on different channels. Concurrent operation may be supported by multiple protocol stacks, for example, one for operation as a WLAN-STA and one for operating as a Wi-Fi Direct device. For example, two separate physical MAC entities may be maintained, each associated with its own PHY entity, or they may use a single PHY entity supporting two virtual MAC entities.

The Wi-Fi Peer-to-Peer Technical Specification v1.1, 2010 published by the Wi-Fi Alliance, provides for provisioning in Wi-Fi Direct networks. Provisioning is a phase of peer-to-peer group formation in which credentials for the peer-to-peer group are exchanged based on the use of Wi-Fi Simple Configuration. Credentials are information that is required to join a peer-to-peer group as defined in the Wi-Fi Simple Configuration Specification.

To allow for peer-to-peer device configuration, peer-to-peer devices may delay starting the provisioning phase until the expiration of the larger of the peer-to-peer group owner's (GO) configuration time and the peer-to-peer client's client configuration time, based on respective configuration timeout attributes exchanged during a preceding group owner negotiation.

The peer-to-peer device selected as peer-to-peer group owner (GO) during group owner negotiation may start a peer-to-peer group session using the credentials it intends to use for that group. The peer-to-peer group owner (GO) may use the operating channel indicated during group owner negotiation, if available. The peer-to-peer client may connect to the peer-to-peer group owner to obtain credentials. If the operating channel is not available the peer-to-peer group owner may use another channel from a channel list attribute sent in the group owner negotiation confirmation frame. The peer-to-peer client may have to scan to find the peer-to-peer group owner if the intended operating channel is not available. A group formation bit in a peer-to-peer group capability bitmap of the peer-to-peer capability attribute may be set to one until provisioning succeeds.

Provisioning may be executed in Wi-Fi Direct networks, as described, for example, in the Wi-Fi Simple Configuration (WSC) Specification, Version 2.0, Dec. 20, 2010. The peer-to-peer group owner (GO) may serve the role as the access point with an internal registrar. It will only allow association by the peer-to-peer device that it is currently with in a group formation. Since the user has entered the WSC PIN or triggered the WSC pushbutton functionality on both devices, the registrar may send an M2 message in response to an M1 message. The peer-to-peer client may serve the role as the STA enrollee. It may associate to the peer-to-peer device that it is currently within the group formation.

If provisioning fails, then group formation ends and the peer-to-peer group owner (GO) may end the peer-to-peer group session. If provisioning fails, the peer-to-peer device may retry group formation or return to device discovery. On successful completion of provisioning in Wi-Fi Direct networks, the peer-to-peer group owner (GO) may set the group formation bit in the peer-to-peer group capability bitmap of the peer-to-peer capability attribute to zero. At this point the peer-to-peer client may join the peer-to-peer group in the Wi-Fi Direct network, using the credentials supplied during provisioning.

Managed P2P Device Operations

This section describes the ability for P2P Devices to operate in an enterprise environment where P2P Devices may be managed by the Information Technology (IT) department of the enterprise.

1. Managed P2P Device Capability

P2P Devices may or may not be managed based on the Managed P2P Device capabilities of P2P Devices and WLAN APs.

A WLAN AP that is capable of managing P2P Devices (e.g. Enterprise IT owned and operated AP) shall include the P2P Manageability attribute with the P2P Device Management bit set to 1 in the P2P IE in Beacon, Probe Response and (Re)association Response frames. The WLAN AP advertises its Managed P2P permissions in the Cross Connection Permitted and Coexistence Optional fields in the P2P Manageability attribute in the P2P IE in Beacon, Probe Response and (Re)association Response frames. A WLAN AP that is capable of managing P2P Devices, but is not a P2P Group Owner, shall not include in the P2P IE attributes other than the P2P Manageability attribute. The P2P Device Management bit set to 0 indicates that the WLAN AP (e.g. Enterprise IT department) has no desire to manage P2P Devices. A WLAN AP that is capable of managing P2P Devices may or may not be a P2P Group Owner.

A Managed P2P Device shall include the P2P Capability attribute with the Infrastructure Managed bit set to 1 in the P2P IE in Probe Request and (Re)association Request frames that are transmitted to the WLAN AP by the WLAN STA interface. Both P2P Group Owners and P2P Clients may be Managed P2P Devices. A value of 0 indicates the device may not be managed by the enterprise IT department.

If the P2P Device is a P2P Group Owner, supports Concurrent Operation (has set the Concurrent Operation bit to 1 in the P2P Capability Subfield) and will use cross connection to the WLAN AP BSS, the Cross Connection bit in the Group Capability Bitmap field of the P2P Capability attribute in (Re)association Request frame shall be set to 1 and set to 0 otherwise.

A Managed P2P Device may be a P2P Concurrent Device that has one MAC entity operating as a WLAN-STA and the second MAC entity operating as a P2P Group Owner.

A Managed P2P Device may also be a P2P Concurrent Device that has one MAC entity operating as a WLAN-STA and the second MAC entity operating as a P2P Client.

If a Managed P2P Device is a P2P Concurrent Device, the WLAN-STA interface of the P2P Device shall include the P2P Interface attribute within a P2P IE in the (Re)association Request frame that is transmitted to the WLAN AP. The Managed P2P Device that is a P2P Concurrent Device shall already have assigned all addresses that may be used as P2P Interface Addresses before the (re)association with the WLAN AP. In this way, a WLAN AP that is capable of managing P2P Devices is notified of all potential P2P Interface Addresses of the Managed P2P Device that is a P2P Concurrent Device in use during the current association with the WLAN AP. WLAN APs that are incapable of managing P2P Devices may also receive this information but cannot parse it.

2. P2P Coexistence Parameters Operations

The Managed P2P Device may gather P2P Coexistence Parameters by using the Channel Usage Procedures as defined in §11.20.14 of IEEE P802.11v, or from (Re)association Response frames received on the WLAN-STA interface from the WLAN AP. The WLAN AP that supports Managed P2P Devices shall include P2P Coexistence Parameters in Probe Response and (Re)association Response frames.

The P2P Coexistence Parameters consist of Primary P2P Coexistence Parameters and Secondary P2P Coexistence Parameters.

The Primary P2P Coexistence Parameters contain Channel Usage information that may be used by IT departments to optimize P2P Devices within the IT defined channel mappings assigned to IT controlled APs. The Managed P2P Device that is a P2P Concurrent Device should use Primary P2P Coexistence Parameters as part of channel selection processing to start a P2P Group. If the P2P Group is already started or the Managed P2P Device is not a P2P Concurrent Device, the Primary P2P Coexistence Parameters may be used by the Managed P2P Device to initiate a channel switch or as part of channel selection processing respectively.

The Secondary P2P Coexistence Parameters consist of P2P Client specific parameters such as maximum transmit power (via the Country and Power Constraint elements) and Wi-Fi Multimedia (WMM) Parameter Element. The Secondary P2P Coexistence Parameters are used to allow Enterprise IT to give WLAN and P2P Devices the same access priority to the medium. The Managed P2P Device that is a P2P Group Owner may use the Secondary P2P Coexistence Parameters as part of determining its maximum transmit power and WMM Parameters Elements for P2P Clients. If the P2P Group Owner is a P2P Concurrent Device in which the P2P Group operates at the same channel with the WLAN BSS, the P2P Group Owner should use the Secondary P2P Coexistence Parameters as part of determining its maximum transmit power and WMM Parameters Elements for P2P Clients. The P2P Group Owner may also set its maximum transmit power and WMM Parameters Elements based on local device decisions that trade off the Enterprise IT benefits and P2P Group benefits. For example, a public printer benefits from longer range more so than a conference room projector; thus, the transmit power may not be the same for the two devices.

In general, application of the P2P Coexistence Parameters to a P2P Group is a device implementation decision. However:
A P2P Concurrent Device that is a Managed P2P Device shall adopt the Primary P2P Coexistence Parameters and recommended Secondary P2P Coexistence Parameters while associated to a WLAN AP that advertises Coexistence Optional set to 0, if the Primary P2P Coexistence Parameters include the WLAN AP's serving channel.
A P2P Concurrent Device that is a Managed P2P Device should adopt the Primary P2P Coexistence Parameters while associated to a WLAN AP that advertises Coexistence Optional set to 0 if (1) the P2P Device is capable of concurrently operating in a WLAN BSS and a P2P Group that are each operating on different bands and (2) the Primary P2P Coexistence Parameters include a channel on a different band than the WLAN AP's serving channel.

The Enterprise IT department may not allow Concurrent P2P Devices to connect to the WLAN infrastructure if these devices do not adhere to these P2P Coexistence Parameters.

Previously, a P2P Client that is a Managed P2P Device does not use the P2P Coexistence Parameters since the Operating Class, Channel and Secondary P2P Coexistence Parameters adopted by a P2P Group were only chosen by the P2P Group Owner.

C. Channel Usage Information Delivery within a Peer-to-Peer Group

In accordance with an example embodiment of the invention, a peer-to-peer wireless client device is a Managed P2P Client Device that is associated with a peer-to-peer wireless group owner device in a peer-to-peer wireless network. The peer-to-peer wireless client device may transmit a channel usage request message to a wireless access point device managing a wireless infrastructure network. The peer-to-peer wireless client device is concurrently operating with the wireless access point device. The peer-to-peer wireless client device is also referred to as a managed Wi-Fi device. The peer-to-peer wireless client device receives a channel usage response message from the wireless access point device, including coexistence information of the wireless infrastructure network. The peer-to-peer wireless client device may then transmit the received coexistence information to the peer-to-peer wireless group owner device, in accordance with at least one embodiment of the present invention.

In accordance with an example embodiment of the invention, the coexistence information may comprises at least channel usage information and optionally also may comprise one or more of power constraint information, Enhanced Distributed Channel Access (EDCA) parameter set information, and transmit power envelope information.

In this manner, the access point may have more control over how peer-to-peer wireless groups operate within its coverage area, thereby enhancing the infrastructure WLAN performance.

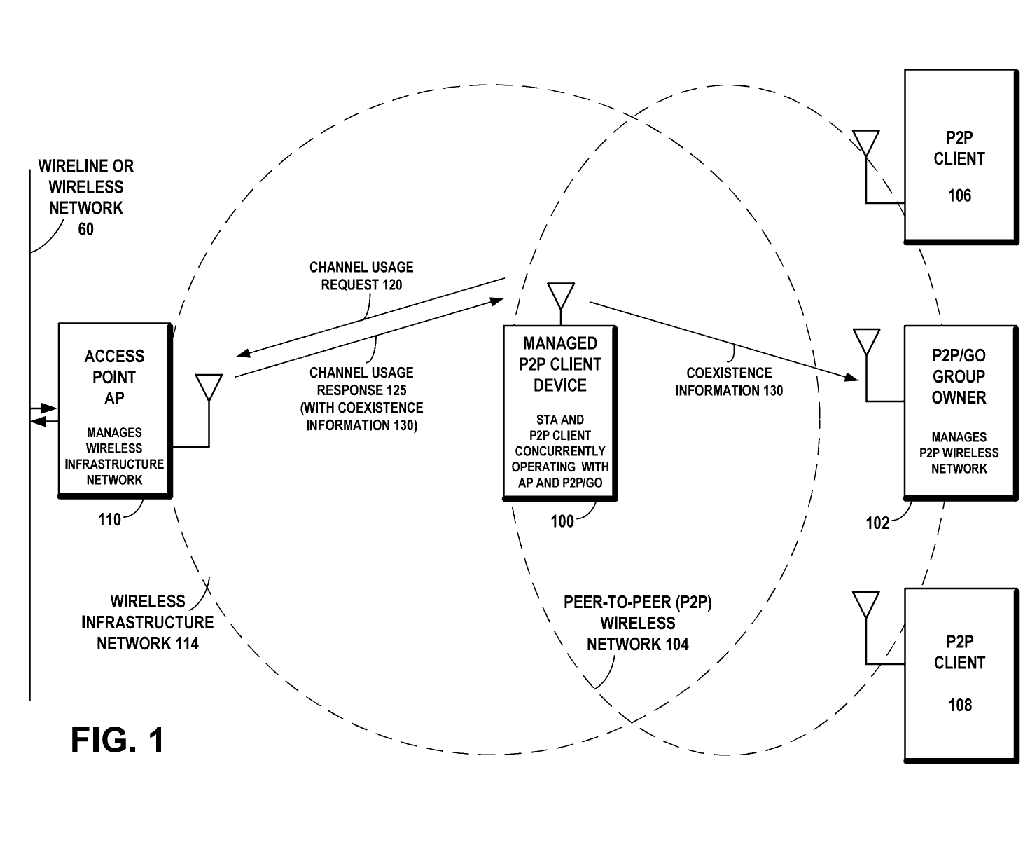

FIG. 1 illustrates an example network diagram of a peer-to-peer wireless client device 100, which is a Managed P2P Client Device, associated with a peer-to-peer wireless group owner device 102 in a peer-to-peer wireless network 104. The peer-to-peer wireless client device 100 is shown transmitting a channel usage request message 120 to a wireless access point (AP) device 110 managing a wireless infrastructure network 114. The peer-to-peer wireless client device 100 is concurrently operating with the wireless access point device 110, which may be connected to a wireline 60 or a wireless network.

If the peer-to-peer wireless client device 100 is not associated with the wireless access point device 110, then the channel usage request message 120 may be a probe request frame that includes a channel usage element. The channel usage response message 125 from the access point device 110 is a probe response frame that includes the coexistence information 130 of the wireless infrastructure network 114. The coexistence information 130 comprises at least channel usage information and optionally also comprises one or more of power constraint information, Enhanced Distributed Channel Access parameter set information, and transmit power envelope information.

Alternately, if the peer-to-peer wireless client device 100 is associated with the wireless access point device 110, then the channel usage request message 120 may be a channel usage request frame. The channel usage response message 125 is a channel usage response frame that includes the coexistence information 130, which comprises at least channel usage information and optionally also comprises one or more of power constraint information, Enhanced Distributed Channel Access parameter set information, and transmit power envelope information.

In accordance with an example embodiment of the invention, the figure shows the peer-to-peer wireless client device 100 transmitting the received coexistence information 130 to the peer-to-peer wireless group owner device 102.

If the peer-to-peer wireless client device 100 is not presently associated to the peer-to-peer wireless group owner device 102, it may embed the received coexistence information 130 in an association request frame and transmit the association request frame to the peer-to-peer wireless group owner device 102.

Alternately, if the peer-to-peer wireless client device 100 is associated to the peer-to-peer wireless group owner device 102, it may transmit the received coexistence information 130 as a channel usage response frame to the peer-to-peer wireless group owner device.

In accordance with an example embodiment, a peer-to-peer (P2P) wireless client device 100 is a Managed P2P Client Device that is concurrently associated with an AP 110 and operates as a P2P client in a P2P group 104, keeps the group owner 102 of the P2P group aware of coexistence information 130 provided by the infrastructure network 114. The Managed P2P Client Device 100 may request the information 130 from the infrastructure network 114 either with Probe Request or Channel Usage Request frames 120. The preferred approach is to use the Channel Usage Request frame. Use of the Channel Usage Request 120 and Response 125 frames, assures that the information source is known and allows the option of the AP transmitting Channel Usage Response frames as group addressed frames. This allows an AP to transmit a Channel Usage Response frame as a group addressed frame whenever the Channel Usage information is updated. A Managed P2P Client Device that has made an earlier request for this information from the AP, is obliged to take into account the information received. Additionally, use of the Channel Usage Request 120 and Response 125 frames allows for the infrastructure network 114 to provide not only channel usage information (primary P2P coexistence parameters), but also power constraint and EDCA parameters (secondary P2P coexistence parameters).

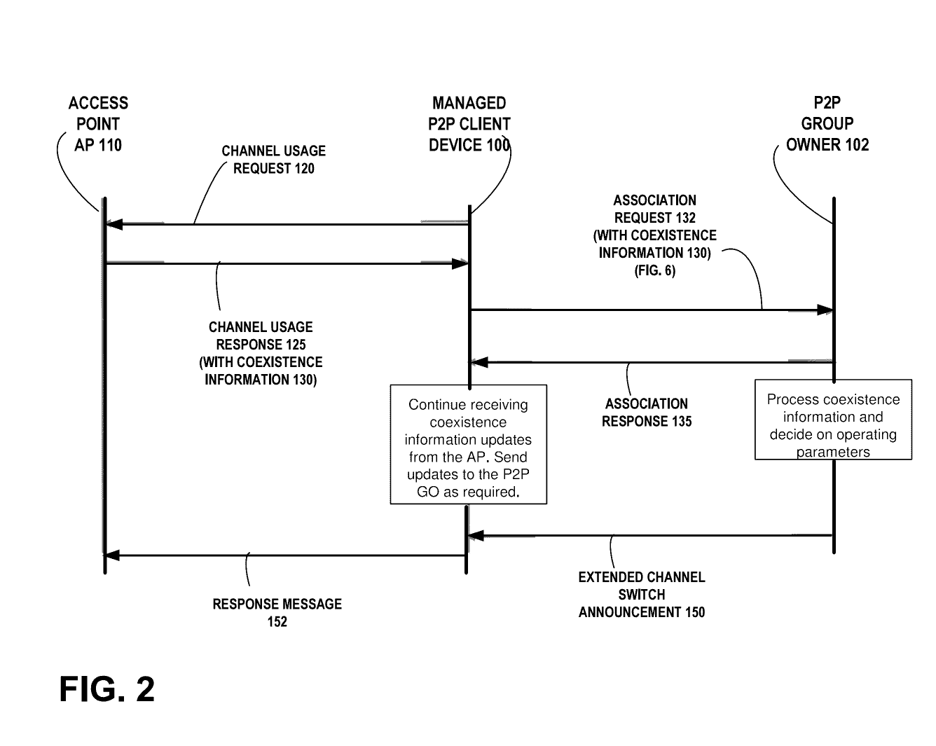

FIG. 2 illustrates a signal sequence diagram of the network shown in FIG. 1, wherein the peer-to-peer wireless client device 100 is not presently associated with the peer-to-peer wireless group owner device 102. The figure shows the peer-to-peer wireless client device 100 receiving a channel usage response message 125 from the wireless access point device 110, including coexistence information 130 of the wireless infrastructure network 114.

The figure shows the peer-to-peer wireless client device 100 embedding the received coexistence information 130 in an association request frame 132 and transmitting the association request frame 132 to the peer-to-peer wireless group owner device 102, in accordance with at least one embodiment of the present invention.

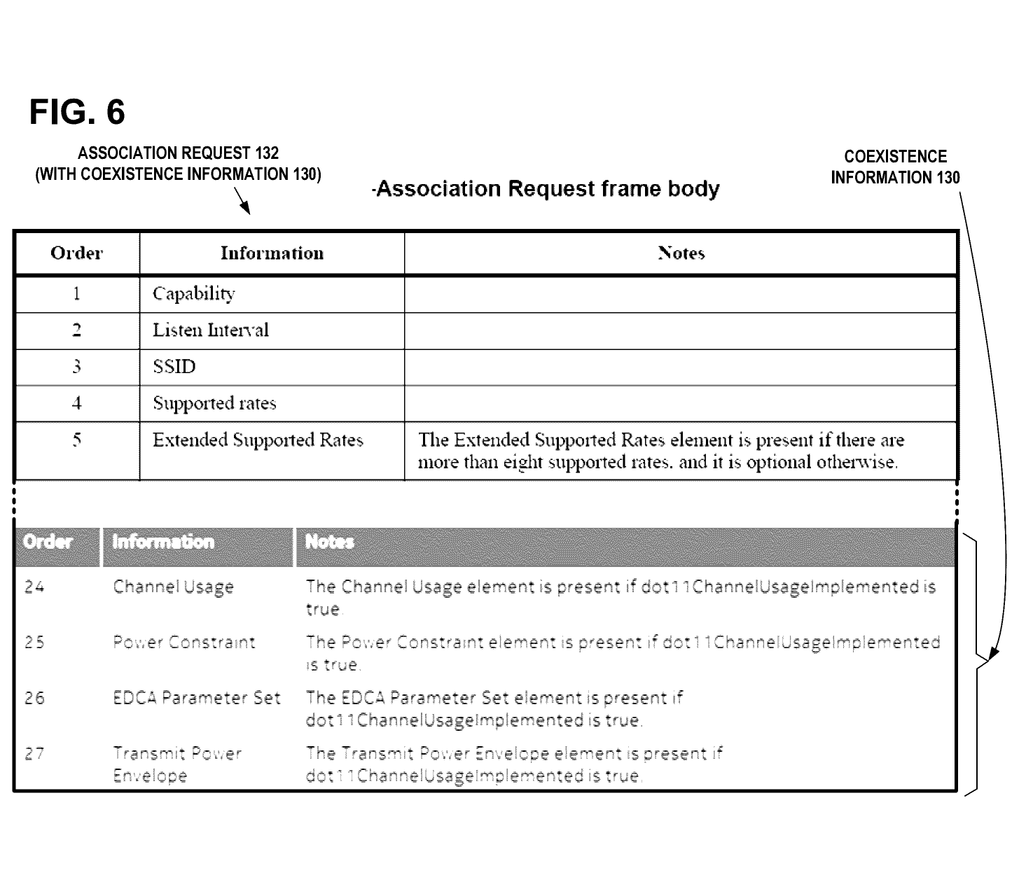

In accordance with an example embodiment, when the peer-to-peer wireless client device 100, which is a Managed P2P Client Device, joins the P2P group 104, it needs to provide the coexistence information 130 to the group owner 102 as soon as possible and feasible. One approach is to embed the coexistence information 130 in the Association Request frame 132, which the Managed P2P Client Device 100 transmits to the group owner. FIG. 6 illustrates the association request frame body with coexistence information 130, transmitted in the association request 132. The coexistence information 130 comprises at least channel usage information and optionally also comprises one or more of power constraint information, Enhanced Distributed Channel Access (EDCA) parameter set information, and transmit power envelope information.

In an example embodiment of the invention, after the peer-to-peer wireless client device 100 has received the channel usage response message 125 from the wireless access point device 110, including coexistence information 130, the peer-to-peer wireless client device 100 may store the coexistence information 130 in its local memory or in a remote storage device. Later, the peer-to-peer wireless client device 100 may associate with another peer-to-peer wireless group owner device in a second peer-to-peer wireless network. The peer-to-peer wireless client device 100 may then access the stored coexistence information 130 from the memory or storage device and transmit the stored coexistence information 130, to the second peer-to-peer wireless group owner device.

In an example embodiment of the invention, the peer-to-peer wireless group owner device 102 may determine to switch the peer-to-peer wireless network 104 to another channel in response to the received coexistence information 130 of the wireless infrastructure network 114. The peer-to-peer wireless group owner device 102 may then report the channel switch selection information to the Managed P2P Client Device 100 in an extended channel switch announcement 150. The Managed P2P Client Device 100 may, in turn, transmit a response message 152 to the infrastructure access point 110, reporting that the P2P group owner 102 has taken action to use the new channel usage information, for example, reporting the channel switch selection information to the AP.

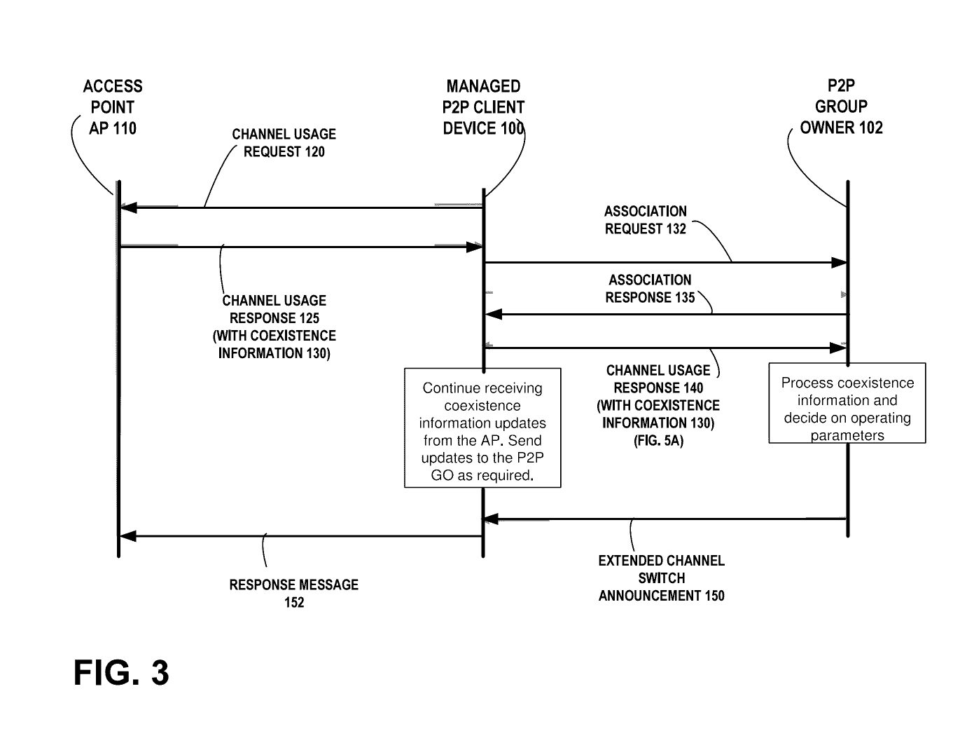

FIG. 3 illustrates a signal sequence diagram of the network shown in FIG. 1, wherein the peer-to-peer wireless client device 100 is not presently associated with the peer-to-peer wireless group owner device 102. The figure shows the peer-to-peer wireless client device 100 receiving a channel usage response message 125 from the wireless access point device 110, including coexistence information 130 of the wireless infrastructure network 114.

The figure shows the peer-to-peer wireless client device 100 transmitting an association request frame 132 to the peer-to-peer wireless group owner device 102, receiving an association response frame 135, and becoming associated with the peer-to-peer wireless group owner device 102.

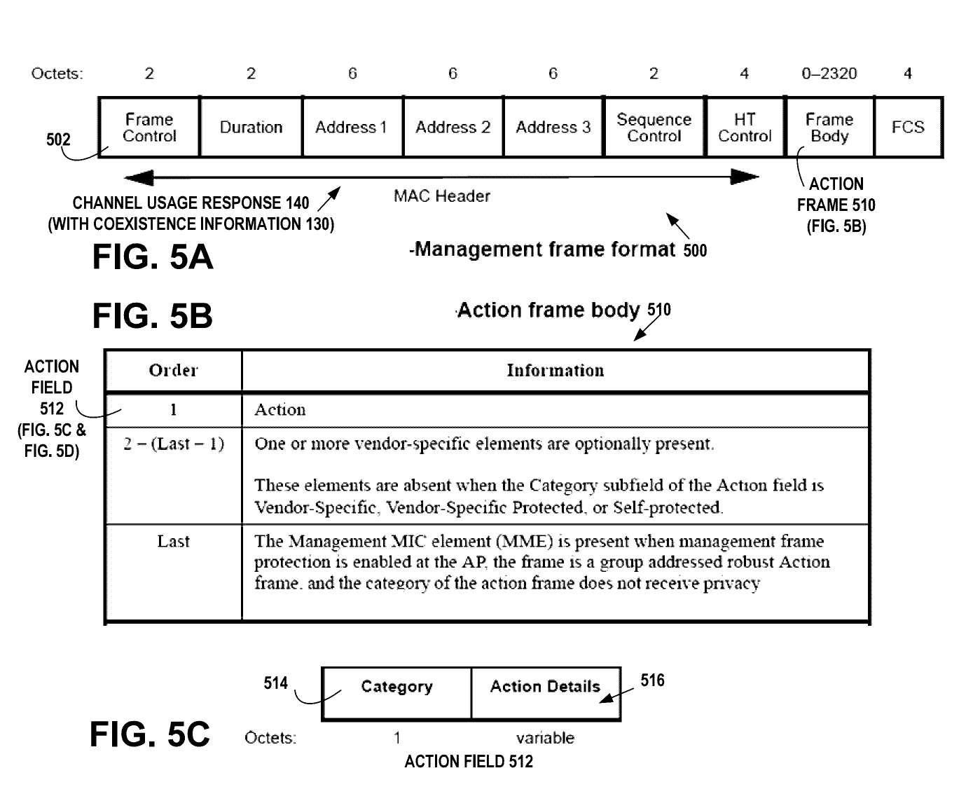

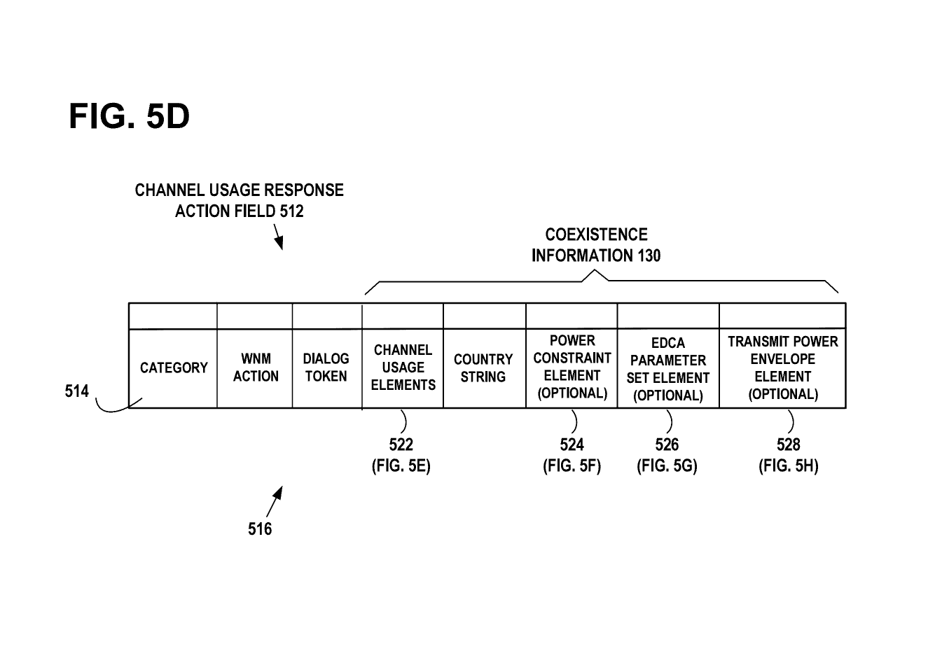

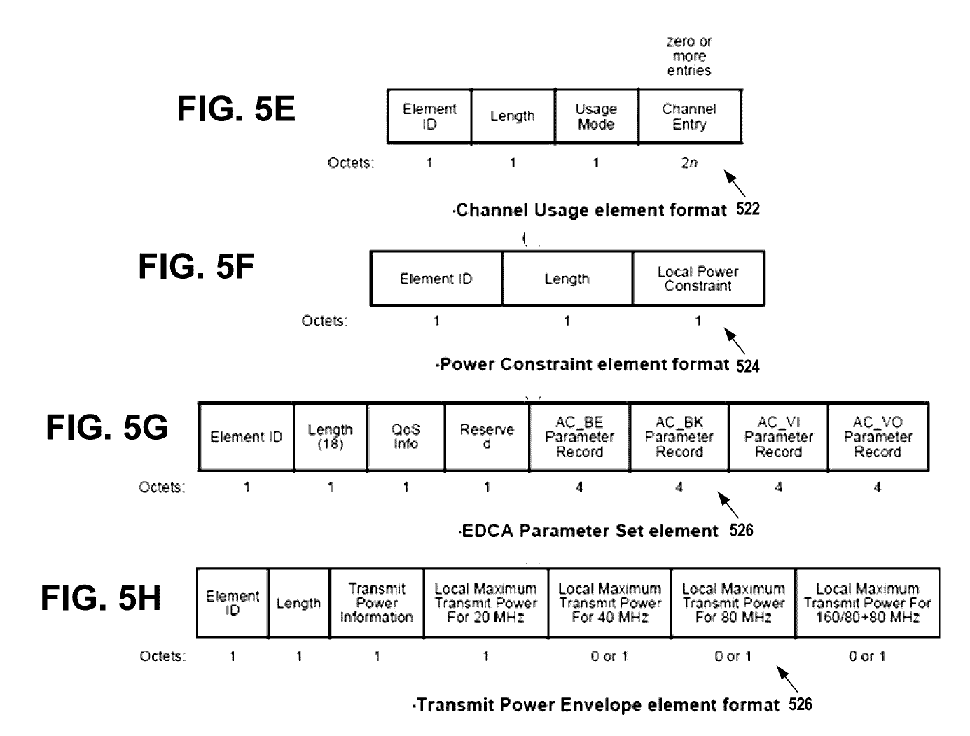

In accordance with an example embodiment of the invention, the figure then shows the peer-to-peer wireless client device 100 transmitting the received coexistence information 130 as a channel usage response frame 140 to the peer-to-peer wireless group owner device 102. The peer-to-peer wireless client device 100 may transmit the channel usage response frame 140 without a request from the group owner 102. FIGS. 5A to 5D show the channel usage response frame 140, which contains the coexistence information 130. FIG. 5A illustrates an example of a management frame format containing a channel usage response action field shown in greater detail in FIG. 5D. The coexistence information 130 comprises at least channel usage information and optionally also comprises one or more of power constraint information, Enhanced Distributed Channel Access (EDCA) parameter set information, and transmit power envelope information.

The channel usage response frame 140 may be transmitted as a unicast frame to the P2P group owner 102. In an example embodiment, the associated P2P client 100 may transmit a Channel Usage Response frame 140 to the P2P group owner 102 without a request from the group owner 102. The Dialog Token field in the response frame 140 shall be set to ‘0’.

In another example embodiment, an associated P2P client 100 may be allowed to transmit a Channel Usage Response frame 140 only after it has received a Channel Usage Request frame from the group owner 102.

In an example embodiment of the invention, the peer-to-peer wireless group owner device 102 may determine to switch the peer-to-peer wireless network 104 to another channel in response to the received coexistence information 130 of the wireless infrastructure network 114. The peer-to-peer wireless group owner device 102 may then report the channel switch selection information to the Managed P2P Client Device 100 in an extended channel switch announcement 150. The Managed P2P Client Device 100 may, in turn, transmit a response message 152 to the infrastructure access point 110, reporting that the P2P group owner 102 has taken action to use the new channel usage information, for example, reporting the channel switch selection information to the AP.

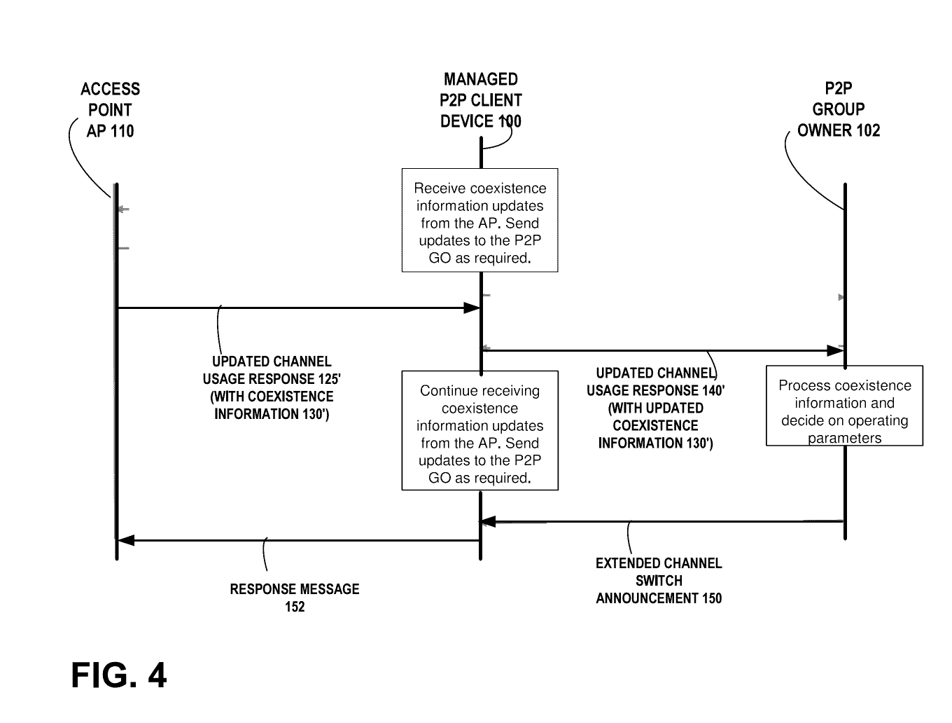

FIG. 4 illustrates a signal sequence diagram of the network shown in FIG. 1, wherein the peer-to-peer wireless client device 100 is shown receiving an updated channel usage response message 125′ from the wireless access point device 110, including updated coexistence information 130′ of the wireless infrastructure network 114. The figure further shows that receiving the update triggers the peer-to-peer wireless client device 100 to transmit the received updated coexistence information 130′ to the peer-to-peer wireless group owner device 102, in an updated Channel Usage Response frame 140′, in accordance with at least one embodiment of the present invention.

Depending on the selected approach, the peer-to-peer wireless client device 100 may need to transmit a Reassociation Request frame or a Channel Usage Response frame to the group owner 102. The peer-to-peer wireless client device 100 will transmit to the group owner 102 the updated set of P2P coexistence parameters, as they are received from the infrastructure network 114.

In an example embodiment of the invention, the peer-to-peer wireless group owner device 102 may determine to switch the peer-to-peer wireless network 104 to another channel in response to the received updated coexistence information 130′ of the wireless infrastructure network 114. The peer-to-peer wireless group owner device 102 may then report the channel switch selection information to the Managed P2P Client Device 100 in an extended channel switch announcement 150. The Managed P2P Client Device 100 may, in turn, transmit a response message 152 to the infrastructure access point 110, reporting that the P2P group owner 102 has taken action to use the new channel usage information, for example, reporting the channel switch selection information to the AP.

A P2P group owner 102 that has one or more associated P2P clients 106 and 108, which are Managed P2P Client Devices, utilizes the P2P coexistence information 130 in the same way as if the group owner device 102 were concurrently directly connected to the infrastructure AP 110 and received the information directly.

If the coexistence information 130 is received by the group owner 102 in an Association Request frame 132, the group owner 102 first processes the association request to determine whether the P2P device 100 from which the request frame 132 was received, is granted association. If association is granted, the group owner 102 processes the received P2P coexistence information 130 parameters. Alternately, if the coexistence information 130 is received in a Channel Usage Response frame 140 from a P2P client 100 associated to the group owner 102, the group owner 102 similarly processes the received coexistence information 130 parameters. Based on the processed coexistence information 130, the group owner 102 decides whether to change some of the operating parameters of the P2P group 104.

FIG. 5A illustrates a management frame format 500 for the channel usage response frame 140. The management frame 500 includes a frame control field 502 that indicates the frame type and a frame body field that contains an action frame 510 shown in FIG. 5B. The action frame 510 contains a channel usage response action field 512 shown in greater detail in FIG. 5D. The channel usage response action field 512 contains the coexistence information 130, in accordance with at least one embodiment of the present invention.

FIG. 5B illustrates the action frame body frame 510 containing the channel usage response action field 512, in accordance with at least one embodiment of the present invention.

FIG. 5C illustrates the action field general format 512, in accordance with at least one embodiment of the present invention.

FIG. 5D illustrates the channel usage response action field 512, in accordance with at least one embodiment of the present invention. The action field 512 includes the coexistence information 130, transmitted in the channel usage response 140. The coexistence information 130 comprises at least channel usage elements 522 shown in FIG. 5E. The coexistence information 130 optionally also comprises one or more of power constraint element 524 shown in FIG. 5F, the Enhanced Distributed Channel Access (EDCA) parameter set element 526 shown in FIG. 5G, and the transmit power envelope element 528 shown in FIG. 5H.

FIG. 5E illustrates the channel usage element format 522 in the channel usage response action field, in accordance with at least one embodiment of the present invention.

FIG. 5F illustrates the optional power constraint element format 524 in the channel usage response action field, in accordance with at least one embodiment of the present invention.

FIG. 5G illustrates the optional Enhanced Distributed Channel Access (EDCA) parameter set element format 526 in the channel usage response action field, in accordance with at least one embodiment of the present invention.

FIG. 5H illustrates the optional transmit power envelope element format 528 in the channel usage response action field, in accordance with at least one embodiment of the present invention.

FIG. 6 illustrates the association request frame body format with coexistence information, transmitted in the association request 132, in accordance with at least one embodiment of the present invention. The association request frame body includes the coexistence information 130, transmitted in the association request 132. The coexistence information 130 comprises at least channel usage information and optionally also comprises one or more of power constraint information, Enhanced Distributed Channel Access (EDCA) parameter set information, and transmit power envelope information.

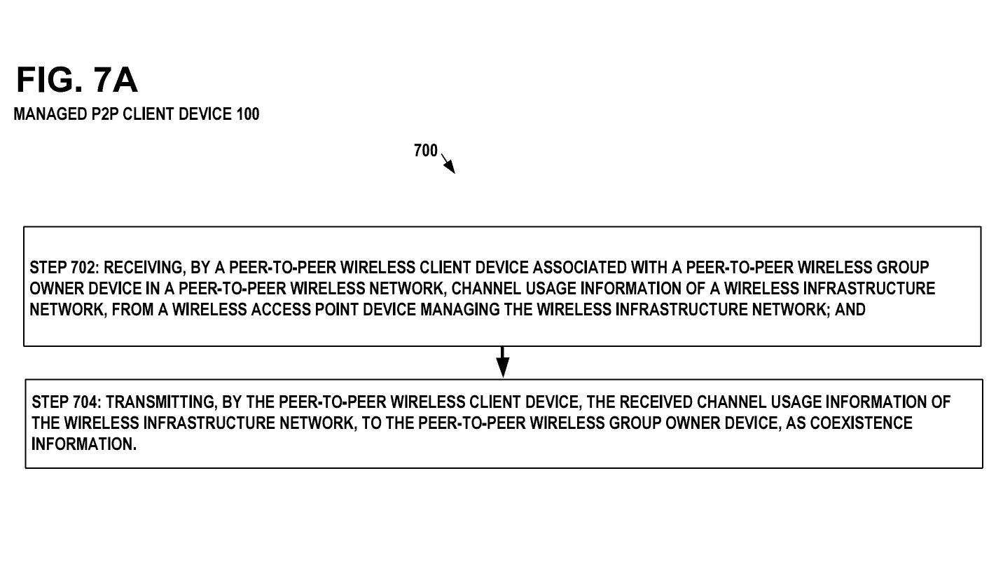

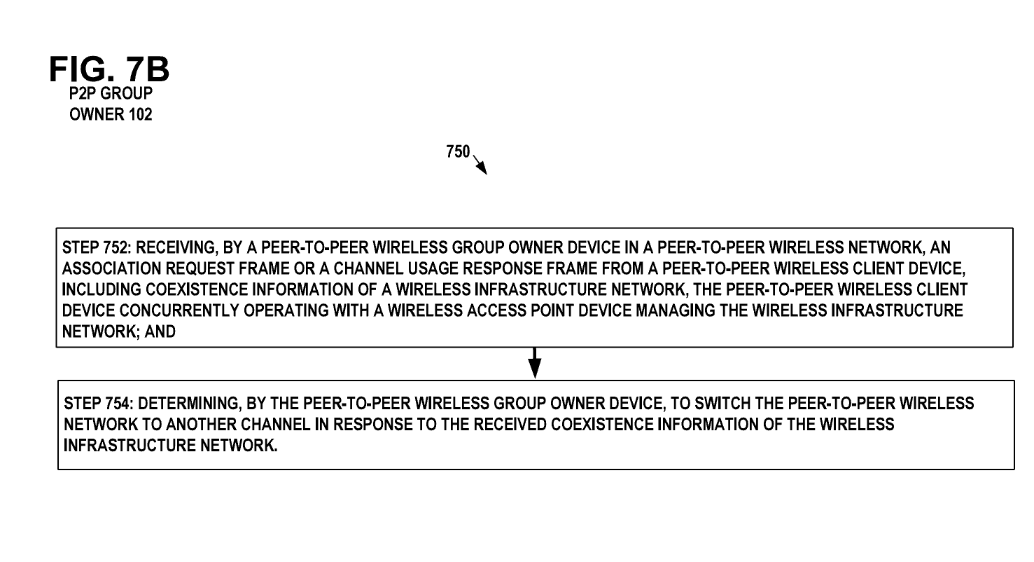

FIG. 7A illustrates an example flow diagram 700 of operational steps in the Managed P2P Client Device 100, in accordance with at least one embodiment of the present invention. The steps of the flow diagram represent computer code instructions stored in the device's RAM and/or ROM memory, which when executed by the device's central processing units (CPU) CPU1 and/or CPU2, carry out the functions of the example embodiments of the invention. The steps may be carried out in another order than shown and individual steps may be combined or separated into component steps. The flow diagram has the following steps:

Step 702: receiving, by a peer-to-peer wireless client device associated with a peer-to-peer wireless group owner device in a peer-to-peer wireless network, channel usage information of a wireless infrastructure network, from a wireless access point device managing the wireless infrastructure network; and

Step 704: transmitting, by the peer-to-peer wireless client device, the received channel usage information of the wireless infrastructure network, to the peer-to-peer wireless group owner device, as coexistence information.

FIG. 7B illustrates an example flow diagram 750 of operational steps in the peer-to-peer wireless group owner device 102, in accordance with at least one embodiment of the present invention. The steps of the flow diagram represent computer code instructions stored in the device's RAM and/or ROM memory, which when executed by the device's central processing units (CPU) CPU1 and/or CPU2, carry out the functions of the example embodiments of the invention. The steps may be carried out in another order than shown and individual steps may be combined or separated into component steps. The flow diagram has the following steps:

Step 752: receiving, by a peer-to-peer wireless group owner device in a peer-to-peer wireless network, an association request frame or a channel usage response frame from a peer-to-peer wireless client device, including coexistence information of a wireless infrastructure network, the peer-to-peer wireless client device concurrently operating with a wireless access point device managing the wireless infrastructure network; and

Step 754: determining, by the peer-to-peer wireless group owner device, to switch the peer-to-peer wireless network to another channel in response to the received coexistence information of the wireless infrastructure network.

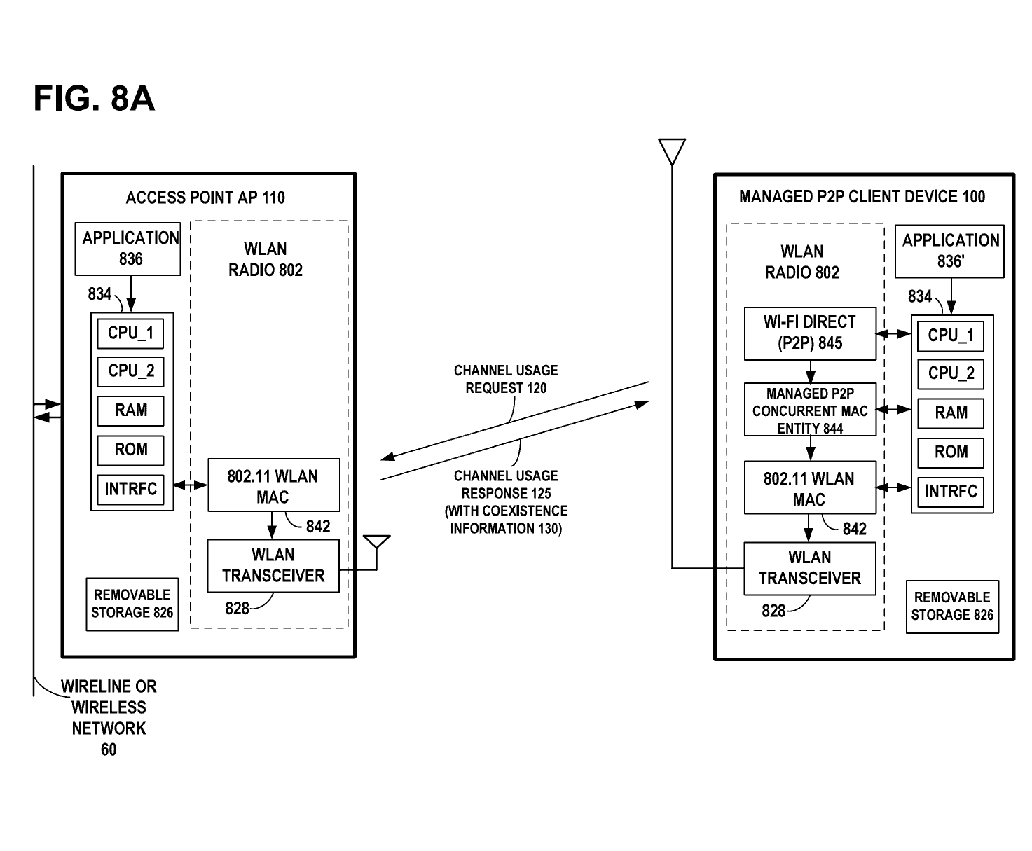

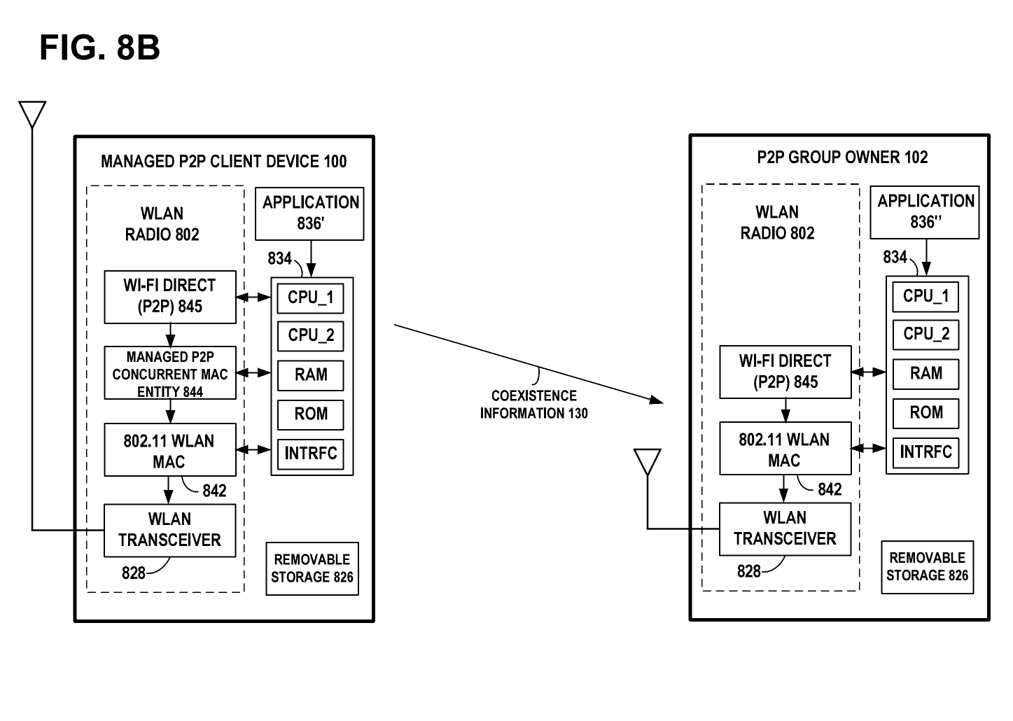

FIG. 8A is an illustrates an example network diagram and functional block diagram of the access point device 110 and the peer-to-peer wireless client device 100, which is a Managed P2P Client Device, in accordance with at least one embodiment of the present invention. The example access point device 110 may include a processor 834 that may include at least one of the following: a dual or multi-core central processing unit CPU_1 and CPU_2, a RAM memory, a ROM memory, and an interface for a keypad, display, and other input/output devices. The example wireless device may include a WLAN protocol stack, including the IEEE 802.11 MAC 842, for communication over the network 114, and WLAN transceiver 828. The WLAN protocol stack may also include an application program 836.

The example peer-to-peer wireless client device 100, which is a Managed P2P Client Device, may include a processor 834 that may include at least one of the following: a dual or multi-core central processing unit CPU_1 and CPU_2, a RAM memory, a ROM memory, and an interface for a keypad, display, and other input/output devices. The example wireless device may include a WLAN protocol stack, including Wi-Fi Direct (P2P) 845 for communication over the P2P wireless network 104, Managed P2P Concurrent MAC entity 844 for concurrent operation in both the P2P wireless network 104 and the BSS network 114, the IEEE 802.11 MAC 842, for communication over the BSS network 114, and WLAN transceiver 828. The WLAN protocol stack may also include an application program 836′.

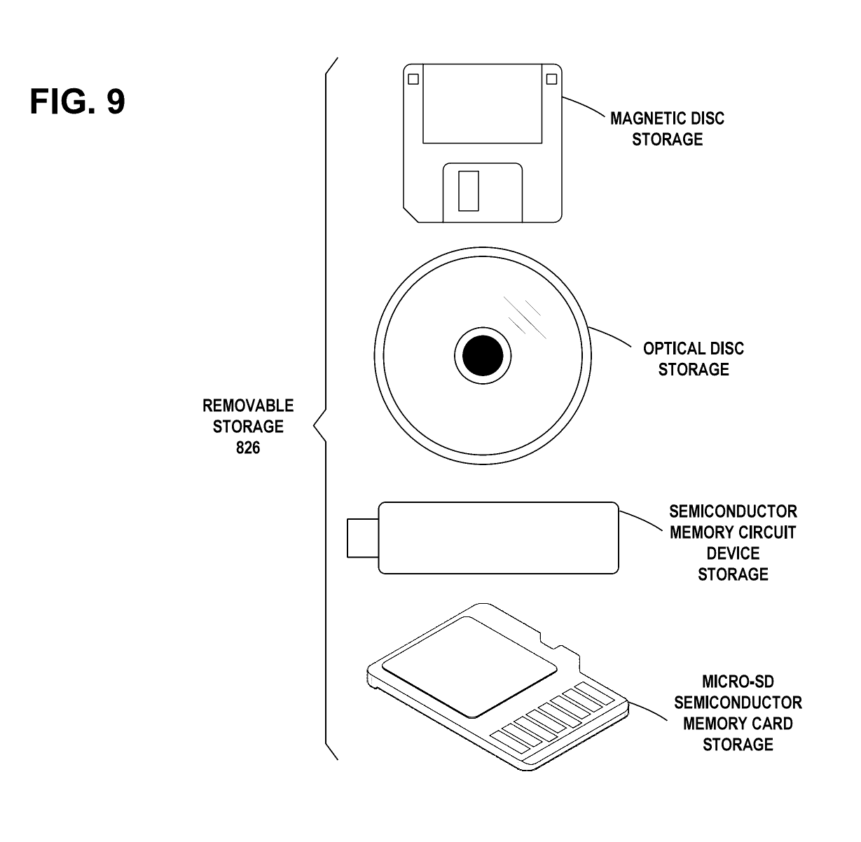

In an example embodiment, the interface circuits may interface with one or more radio transceivers, battery and other power sources, key pad, touch screen, display, microphone, speakers, ear pieces, camera or other imaging devices, etc. The RAM and ROM may be removable memory devices 826 such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 826, as shown in FIG. 9, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

FIG. 8B is an illustrates an example network diagram and functional block diagram of the peer-to-peer wireless client device 100 and the peer-to-peer wireless group owner device 102, in accordance with at least one embodiment of the present invention. The example peer-to-peer wireless group owner device 102, may optionally be a Managed P2P Device. The example peer-to-peer wireless group owner device 102 may include a processor 834 that may include at least one of the following: a dual or multi-core central processing unit CPU_1 and CPU_2, a RAM memory, a ROM memory, and an interface for a keypad, display, and other input/output devices. The example wireless device may include a WLAN protocol stack, including Wi-Fi Direct (P2P) 845 for communication over the P2P wireless network 104, the IEEE 802.11 MAC 842, for communication over the BSS network 114, and WLAN transceiver 828. The WLAN protocol stack may also include an application program 836″.

In an example embodiment, the interface circuits may interface with one or more radio transceivers, battery and other power sources, key pad, touch screen, display, microphone, speakers, ear pieces, camera or other imaging devices, etc. The RAM and ROM may be removable memory devices 826 such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 826, as shown in FIG. 9, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

FIG. 9 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with an example embodiment of the invention.

What is claimed is:

1. A method, comprising:
receiving, by a peer-to-peer wireless client device associated with a peer-to-peer wireless group owner device in a peer-to-peer wireless network, channel usage information of a wireless infrastructure network, from a wireless access point device managing the wireless infrastructure network; and
transmitting, by the peer-to-peer wireless client device, the received channel usage information of the wireless infrastructure network, to the peer-to-peer wireless group owner device, as coexistence information.

2. The method of claim 1, further comprising:
transmitting, by the peer-to-peer wireless client device, to the wireless access point device, a probe request frame that includes a channel usage element; and
receiving, by the peer-to-peer wireless client device, from the wireless access point device, a probe response frame that includes the channel usage information;
wherein the peer-to-peer wireless client device is not associated with the wireless access point device.

3. The method of claim 1, further comprising:
transmitting, by the peer-to-peer wireless client device, to the wireless access point device, a channel usage request frame; and
receiving, by the peer-to-peer wireless client device, from the wireless access point device, a channel usage response frame that includes the channel usage information, the channel usage response frame optionally also comprising one or more of power constraint information, Enhanced Distributed Channel Access parameter set information, and transmit power envelope information;
wherein the peer-to-peer wireless client device is associated with the wireless access point device.

4. The method of claim 1, further comprising:
embedding, by the peer-to-peer wireless client device, the coexistence information in an association request frame; and
transmitting, by the peer-to-peer wireless client device, the association request frame to the peer-to-peer wireless group owner device.

5. The method of claim 1, further comprising:
transmitting, by the peer-to-peer wireless client device, the coexistence information in a channel usage response frame to the peer-to-peer wireless group owner device.

6. The method of claim 1, further comprising:
receiving, by the peer-to-peer wireless client device, updated channel usage information of the wireless infrastructure network, from the wireless access point device; and
transmitting, by the peer-to-peer wireless client device, the received updated channel usage information, to the peer-to-peer wireless group owner device, as updated coexistence information, when the updated information is received.

7. The method of claim 1, further comprising:
receiving, by the peer-to-peer wireless client device, a channel switch announcement message from the peer-to-peer wireless group owner device, including channel switch selection information of the peer-to-peer wireless network, in response to the coexistence information transmitted to the peer-to-peer wireless group owner device; and
transmitting, by the peer-to-peer wireless client device, the received channel switch selection information to the wireless access point device.

8. The method of claim 1, further comprising:
storing, by the peer-to-peer wireless client device, the coexistence information;
associating, by the peer-to-peer wireless client device, with a second peer-to-peer wireless group owner device in a second peer-to-peer wireless network; and
transmitting, by the peer-to-peer wireless client device, the stored coexistence information, to the second peer-to-peer wireless group owner device.

9. An apparatus, comprising:
at least one processor;
at least one memory including computer program code;
the at least one memory and the computer program code configured to, with the at least one processor, cause the apparatus at least to:
receive by the apparatus associated with a peer-to-peer wireless group owner device in a peer-to-peer wireless network, channel usage information of a wireless infrastructure network, from a wireless access point device managing the wireless infrastructure network; and
transmit the received channel usage information of the wireless infrastructure network, to the peer-to-peer wireless group owner device, as coexistence information.

10. The apparatus of claim 9, further comprising:
the at least one memory and the computer program code configured to, with the at least one processor, cause the apparatus at least to:
transmit to the wireless access point device, a probe request frame that includes a channel usage element; and
receive from the wireless access point device, a probe response frame that includes the channel usage information;
wherein the apparatus is not associated with the wireless access point device.

11. The apparatus of claim 9, further comprising:
the at least one memory and the computer program code configured to, with the at least one processor, cause the apparatus at least to:
transmit to the wireless access point device, a channel usage request frame; and
receive from the wireless access point device, a channel usage response frame that includes the channel usage information, the channel usage response frame optionally also comprising one or more of power constraint information, Enhanced Distributed Channel Access parameter set information, and transmit power envelope information;
wherein the apparatus is associated with the wireless access point device.

12. The apparatus of claim 9, further comprising:
the at least one memory and the computer program code configured to, with the at least one processor, cause the apparatus at least to:
embed the coexistence information in an association request frame; and
transmit the association request frame to the peer-to-peer wireless group owner device.

13. The apparatus of claim 9, further comprising:
the at least one memory and the computer program code configured to, with the at least one processor, cause the apparatus at least to:
transmit the coexistence information in a channel usage response frame to the peer-to-peer wireless group owner device.

14. The apparatus of claim 9, further comprising:
the at least one memory and the computer program code configured to, with the at least one processor, cause the apparatus at least to:
receive updated channel usage information of the wireless infrastructure network, from the wireless access point device; and
transmit the received updated channel usage information, to the peer-to-peer wireless group owner device, as updated coexistence information, when the updated information is received.

15. The apparatus of claim 9, further comprising:
the at least one memory and the computer program code configured to, with the at least one processor, cause the apparatus at least to:
receive a channel switch announcement message from the peer-to-peer wireless group owner device, including channel switch selection information of the peer-to-peer wireless network, in response to the coexistence information transmitted to the peer-to-peer wireless group owner device; and
transmit the received channel switch selection information to the wireless access point device.

16. The apparatus of claim 9, further comprising:
the at least one memory and the computer program code configured to, with the at least one processor, cause the apparatus at least to:
store the coexistence information;
associate with a second peer-to-peer wireless group owner device in a second peer-to-peer wireless network; and
transmit the stored coexistence information, to the second peer-to-peer wireless group owner device.

17. A computer program product comprising computer executable program code recorded on a computer readable non-transitory storage medium, the computer executable program code comprising:
code for receiving, by a peer-to-peer wireless client device associated with a peer-to-peer wireless group owner device in a peer-to-peer wireless network, channel usage information of a wireless infrastructure network, from a wireless access point device managing the wireless infrastructure network; and
code for transmitting, by the peer-to-peer wireless client device, the received channel usage information of the wireless infrastructure network, to the peer-to-peer wireless group owner device, as coexistence information.

18. The computer program product of claim 17, further comprising:
code for transmitting, by the peer-to-peer wireless client device, to the wireless access point device, a probe request frame that includes a channel usage element; and
code for receiving, by the peer-to-peer wireless client device, from the wireless access point device, a probe response frame that includes the channel usage information;
wherein the peer-to-peer wireless client device is not associated with the wireless access point device.

19. The computer program product of claim 17, further comprising:
code for transmitting, by the peer-to-peer wireless client device, to the wireless access point device, a channel usage request frame; and
code for receiving, by the peer-to-peer wireless client device, from the wireless access point device, a channel usage response frame that includes the channel usage information, the channel usage response frame optionally also comprising one or more of power constraint information, Enhanced Distributed Channel Access parameter set information, and transmit power envelope information;
wherein the peer-to-peer wireless client device is associated with the wireless access point device.

20. The computer program product of claim 17, further comprising:
code for embedding, by the peer-to-peer wireless client device, the coexistence information in an association request frame; and
code for transmitting, by the peer-to-peer wireless client device, the association request frame to the peer-to-peer wireless group owner device.

21. The computer program product of claim 17, further comprising:
code for transmitting, by the peer-to-peer wireless client device, the coexistence information in a channel usage response frame to the peer-to-peer wireless group owner device.

22. The computer program product of claim 17, further comprising:
code for receiving, by the peer-to-peer wireless client device, updated channel usage information of the wireless infrastructure network, from the wireless access point device; and
code for transmitting, by the peer-to-peer wireless client device, the received updated channel usage information, to the peer-to-peer wireless group owner device, as updated coexistence information, when the updated information is received.

23. The computer program product of claim 17, further comprising:
code for receiving, by the peer-to-peer wireless client device, a channel switch announcement message from the peer-to-peer wireless group owner device, including channel switch selection information of the peer-to-peer wireless network, in response to the coexistence information transmitted to the peer-to-peer wireless group owner device; and
code for transmitting, by the peer-to-peer wireless client device, the received channel switch selection information to the wireless access point device.

24. A method, comprising:
receiving, by a peer-to-peer wireless group owner device in a peer-to-peer wireless network, an association request frame or a channel usage response frame from a peer-to-peer wireless client device, including coexistence information of a wireless infrastructure network, the peer-to-peer wireless client device concurrently operating with a wireless access point device managing the wireless infrastructure network; and
determining, by the peer-to-peer wireless group owner device, to switch the peer-to-peer wireless network to another channel in response to the received coexistence information of the wireless infrastructure network.

25. An Apparatus, comprising:
at least one processor;
at least one memory including computer program code;
the at least one memory and the computer program code configured to, with the at least one processor, cause the apparatus at least to:
receive in a peer-to-peer wireless network, an association request frame or a channel usage response frame from a peer-to-peer wireless client device, including coexistence information of a wireless infrastructure network, the peer-to-peer wireless client device concurrently operating with a wireless access point device managing the wireless infrastructure network; and
determine to switch the peer-to-peer wireless network to another channel in response to the received coexistence information of the wireless infrastructure network.
